(19) United States
(12) Patent Application Publication
(10) Pub. No.: US 2021/0101600 A1
(43) Pub. Date: Apr. 8, 2021

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Daichi Kato, Wako-shi (JP); Nozomu Hirosawa, Wako-shi (JP)

(21) Appl. No.: 17/036,191

(22) Filed: Sep. 29, 2020

(30) Foreign Application Priority Data
Oct. 7, 2019 (JP) 2019-184729

(51) Int. Cl. B60W 30/18; B60W 30/14; B60W 40/04; G06K 9/00; B60Q 1/50

(52) U.S. Cl. CPC B60W 30/18163; B60W 30/143; B60W 40/04; B60W 2554/404; B60Q 1/50; B60W 2552/53; G06K 9/00791

(57) ABSTRACT

A vehicle control device includes: a recognizer configured to recognize surrounding conditions of a host vehicle; a driving controller configured to control one or both of speed and steering of the host vehicle on the basis of the surrounding conditions recognized the recognizer; and an outside notifier configured to notify an outside of the host vehicle of a lane change destination of the host vehicle. The driving controller is configured to change a time or a distance until lane change from a host vehicle travel lane in which the host vehicle is traveling to a neighboring lane which is adjacent to the host vehicle travel lane is stopped depending on whether the outside of the host vehicle is notified of the lane change destination by the outside notifier when stopping conditions of the lane change are satisfied at the time of starting of the lane change.

### CROSS-REFERENCE TO RELATED APPLICATION

Priority is claimed on Japanese Patent Application No. 2019-184729, filed Oct. 7, 2019, the content of which is incorporated herein by reference.

### BACKGROUND

### Field of the Invention

The invention relates to a vehicle control device, a vehicle control method, and a storage medium.

### Description of Related Art

Recently, automatic control of a vehicle has been studied. In this regard, a technique of stopping overtaking travel or notifying an occupant of a control state based on change in relative speed between an overtaking target vehicle and a host vehicle or detection of lane change of a following vehicle when lane change control for overtaking an overtaking target vehicle is performed is known (for example, see Japanese Unexamined Patent Application, First Publication No. 2016-4443)

### SUMMARY

However, since sufficient information associated with stopping of lane change of the host vehicle is not provided, unease may be caused for an occupant or a nearby vehicle.

Aspects of the invention are made in consideration of the above-mentioned circumstances and an objective thereof is to provide a vehicle control device, a vehicle control method, and a storage medium that can perform more accurate driving control.

The following configurations are employed as a vehicle control device, a vehicle control method, and a storage medium according to the invention.

(1) A vehicle control device according to an aspect of the invention is a vehicle control device including: a recognizer configured to recognize surrounding conditions of a host vehicle; a driving controller configured to control one or both of speed and steering of the host vehicle on the basis of the surrounding conditions recognized by the recognizer; and an outside notifier configured to notify an outside of the host vehicle of a lane change destination of the host vehicle, wherein the driving controller is configured to change a time or a distance until lane change from a host vehicle travel lane in which the host vehicle is traveling to a neighboring lane which is adjacent to the host vehicle travel lane is stopped depending on whether the outside of the host vehicle is notified of the lane change destination by the outside notifier when stopping conditions of the lane change are satisfied at the time of starting of the lane change.

(2) In the aspect of (1), the driving controller may be configured, at the time of starting of the lane change, to stop the lane change when the outside of the host vehicle is not notified of the lane change destination by the outside notifier and a first predetermined time has elapsed after the stopping conditions have been satisfied, and to stop the lane change when the outside of the host vehicle is notified of the lane change destination by the outside notifier and a second predetermined time which is shorter than the first predetermined time has elapsed.

(3) In the aspect of (2), the driving controller may be configured to change one or both of the first predetermined time and the second predetermined time on the basis of the speed of the host vehicle.

(4) In the aspect of (2), the driving controller may be configured to change one or both of the first predetermined time and the second predetermined time on the basis of a road type or a road condition in which the host vehicle is traveling.

(5) In the aspect of (2), the driving controller may be configured to change one or both of the first predetermined time and the second predetermined time on the basis of details of the stopping conditions for stopping the lane change.

(6) In the aspect of (1), the vehicle control device may further include an inside notifier configured to notify an occupant of the host vehicle when the lane change of the host vehicle is executable or when the lane change of the host vehicle is stopped.

(7) In the aspect of (2), the driving controller may be configured to perform the lane change including lateral movement to the neighboring lane when a third predetermined time other than the first predetermined time and the second predetermined time has elapsed or the host vehicle has traveled a third predetermined distance after the outside of the host vehicle has been notified of the lane change destination by the outside notifier.

(8) In the aspect of (1), the driving controller may be configured to determine whether the lane change is to be performed on the basis of a reference position of the host vehicle relative to the host vehicle travel lane and the neighboring lane when the stopping conditions are satisfied in a state in which the lane change including lateral movement to the neighboring lane is being performed and to continuously perform the lane change to the neighboring lane when the reference position of the host vehicle is located in the neighboring lane over a lane marking for partitioning the host vehicle travel lane and the neighboring lane.

(9) In the aspect of (2), the driving controller may be configured to start lateral movement of the host vehicle to the neighboring lane when the stopping conditions are not satisfied within the first predetermined time after the stopping conditions have been satisfied before the outside of the host vehicle has been notified of the lane change destination by the outside notifier or when the stopping conditions are not satisfied within the second predetermined time after the stopping conditions have been satisfied after the outside of the host vehicle has been notified of the lane change destination by the outside notifier.

(10) A vehicle control method according to an aspect of the invention is a vehicle control method which is performed by an onboard computer, the vehicle control method including: recognizing surrounding conditions of a host vehicle; controlling one or both of speed and steering of the host vehicle on the basis of the recognized surrounding conditions; causing an outside notifier to notify an outside of the host vehicle of a lane change destination of the host vehicle; and changing a time or a distance until lane change from a host vehicle travel lane in which the host vehicle is traveling to a neighboring lane which is adjacent to the host vehicle travel lane is stopped depending on whether the outside of the host vehicle is notified of the lane change destination by the outside notifier when stopping conditions of the lane change are satisfied at the time of starting of the lane change.

(11) A storage medium according to an aspect of the invention is a non-transitory computer-readable storage medium having a program stored therein, the program causing an onboard computer to perform: recognizing surrounding conditions of a host vehicle; controlling one or both of speed and steering of the host vehicle on the basis of the recognized surrounding conditions; causing an outside notifier to notify an outside of the host vehicle of a lane change destination of the host vehicle; and changing a time or a distance until lane change from a host vehicle travel lane in which the host vehicle is traveling to a neighboring lane which is adjacent to the host vehicle travel lane is stopped depending on whether the outside of the host vehicle is notified of the lane change destination by the outside notifier when stopping conditions of the lane change are satisfied at the time of starting of the lane change.

According to the aspects of (1) to (11), it is possible to perform more accurate driving control.

### BRIEF DESCRIPTION OF THE DRAWINGS

FIG. 1 is a diagram illustrating a configuration of a vehicle system employing a vehicle control device according to an embodiment;

FIG. 2 is a diagram illustrating functional configurations of a first controller and a second controller;

FIG. 3 is a diagram illustrating lane change control in a first control pattern;

FIG. 4 is a diagram illustrating switching times of various types of devices or control which are associated with lane change control in the first control pattern;

FIG. 5 is a diagram illustrating an example of an image which is output to a display in the first control pattern;

FIG. 6 is a diagram schematically illustrating an example in which a lane change target position is set to a lane;

FIG. 7 is a diagram illustrating lane change control in a second control pattern;

FIG. 8 is a diagram illustrating switching times of various types of devices or control which are associated with lane change control in the second control pattern;

FIG. 9 is a diagram illustrating an example of an image which is output to a display in the second control pattern;

FIG. 10 is a diagram illustrating lane change control in a third control pattern;

FIG. 11 is a diagram illustrating switching times of various types of devices or control which are associated with lane change control in the third control pattern;

FIG. 12 is a diagram illustrating an example of an image indicating that execution of lane change is waited for in the third control pattern;

FIG. 13 is a diagram illustrating lane change control in a fourth control pattern;

FIG. 14 is a flowchart illustrating an example of a process flow which is performed by an automated driving controller according to the embodiment;

FIG. 15 is a flowchart illustrating an example of a flow of a lane change performing process which is illustrated in Step S160; and

FIG. 16 is a diagram illustrating an example of a hardware configuration of the automated driving controller according to the embodiment.

### DESCRIPTION OF EMBODIMENTS

Hereinafter, a vehicle control device, a vehicle control method, and a storage medium according to an embodiment of the invention will be described with reference to the accompanying drawings. In the following description, it is assumed that the vehicle control device is applied to a vehicle which is driven by automated driving. Automated driving is, for example, to execute driving control by automatically controlling one or both of steering and speed of a vehicle. This driving control includes driving control such as an adaptive cruise control system (ACC), a traffic jam pilot (TJP) system, an automated lane change (ALC) system, a lane keeping assistance system (LKAS), or a collision mitigation brake system (CMBS). The automated driving includes first driving control in which driving control is performed in response to an instruction (a request) from an occupant and second driving control in which driving control is performed in response to a request from a system side instead of an instruction from an occupant, for example, when the driving control is able to be executed on the basis of surrounding conditions of a vehicle or the like. For example, the second driving control is control with urgency or priority higher than that in the first driving control. In an automated-driving vehicle, driving control based on an occupant's manual operation (so-called manual driving) may be performed. In the following description, it is assumed that the rule of driving on the left-hand side is applied, but right and left may be exchanged with each other when the rule of driving on the right-hand side is applied.

[Overall Configuration]

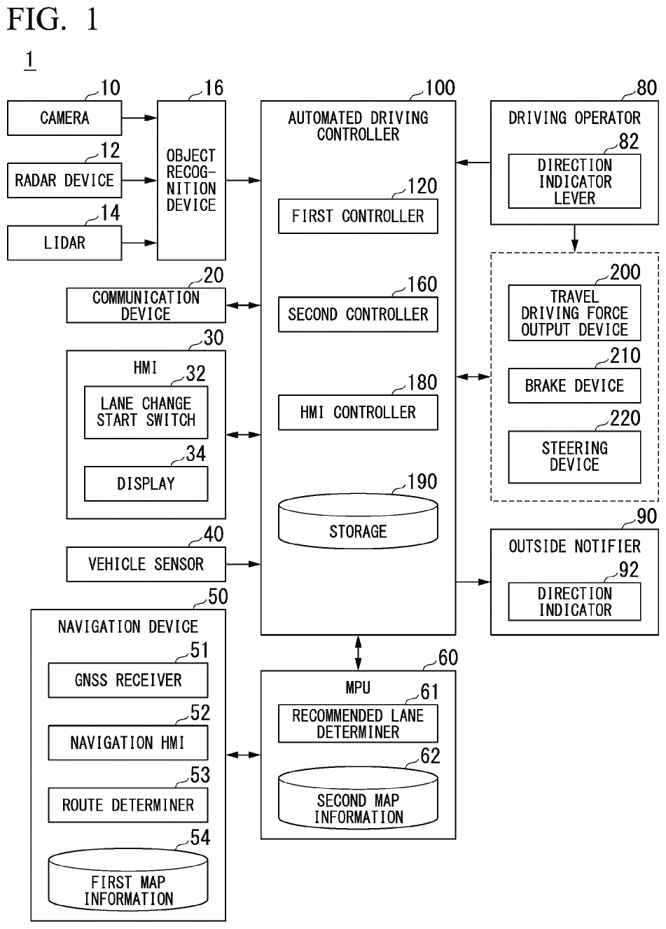

FIG. 1 is a diagram illustrating a configuration of a vehicle system 1 employing a vehicle control device according to an embodiment. A vehicle in which the vehicle system 1 is mounted (hereinafter referred to as a host vehicle M) is, for example, a vehicle with two wheels, three wheels, or four wheels and a drive source thereof is an internal combustion engine such as a diesel engine or a gasoline engine, an electric motor, or a combination thereof. An electric motor operates using electric power which is generated by a power generator connected to the internal combustion engine or electric power which is discharged from a battery (a storage battery) such as a secondary battery or a fuel cell.

The vehicle system 1 includes, for example, a camera 10, a radar device 12, a Light Detection and Ranging (LIDAR) 14, an object recognition device 16, a communication device 20, a human-machine interface (HMI) 30, a vehicle sensor 40, a navigation device 50, a map positioning unit (MPU) 60, a driving operator 80, an outside notifier 90, an automated driving controller 100, a travel driving force output device 200, a brake device 210, and a steering device 220. These devices or instruments are connected to each other via a multiplex communication line such as a controller area network (CAN) communication line, a serial communication line, a radio communication network, or the like. The configuration illustrated in FIG. 1 is only an example and a part of the configuration may be omitted or another configuration may be added thereto. A combination of the HMI 30, the driving operator 80, the automated driving controller 100, and the outside notifier 90 is an example of a “vehicle control device.” A combination of the HMI 30 and the driving operator 80 is an example of an “operation receiver.” The HMI 30 is an example of an “inside notifier.” In the automated driving controller 100, a combination of a first controller 120 and a second controller 160 is an example of a “driving controller,” and an HMI controller 180 is an example of a “notification controller.”

The camera 10 is, for example, a digital camera using a solid-state imaging device such as a charge coupled device (CCD) or a complementary metal oxide semiconductor (CMOS). The camera 10 is attached to an arbitrary position on a vehicle in which the vehicle system 1 is mounted. For example, when the front view of the host vehicle M is imaged, the camera 10 is attached to an upper part of a front windshield, a rear surface of a rearview mirror, or the like. The camera 10 images surroundings of the host vehicle M, for example, periodically and repeatedly. The camera 10 may be a stereoscopic camera.

The radar device 12 radiates radio waves such as millimeter waves to the surroundings of the host vehicle M, detects radio waves (reflected waves) reflected by an object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The LIDAR 14 applies light to the surroundings of the host vehicle M and measures scattered light. The LIDAR 14 detects a distance to an object on the basis of a time from emission of light to reception of light. The light which is applied is, for example, a pulse-like laser beam. The LIDAR 14 is attached to an arbitrary position on the host vehicle M.

The object recognition device 16 performs a sensor fusion process on results of detection from some or all of the camera 10, the radar device 12, and the LIDAR 14 and recognizes a position, a type, a speed, and the like of an object. The object recognition device 16 outputs the result of recognition to the automated driving controller 100. The object recognition device 16 may output the results of detection from the camera 10, the radar device 12, and the LIDAR 14 to the automated driving controller 100 without any change. In this case, the object recognition device 16 may be omitted from the vehicle system 1.

The communication device 20 communicates with, for example, other vehicles near the host vehicle M, a terminal device of a user who uses the host vehicle M, or various types of server devices using a network such as a cellular network, a Wi-Fi network, Bluetooth (registered trademark), or dedicated short range communication (DSRC), a local area network (LAN), a wide area network (WAN), or the Internet.

The HMI 30 delivers or presents various types of information to an occupant of the host vehicle M and receives an input operation from the occupant. The HMI 30 includes, for example, a lane change start switch 32 and a display 34. The lane change start switch 32 is, for example, a switch that is used to perform lane change control for changing a lane of the host vehicle M using the automated driving controller 100 regardless of an occupant's steering operation or accelerating/decelerating operation. A steering operation is, for example, an operation of a steering wheel which is included in the driving operator 80. An accelerating/decelerating operation is, for example, an operation on an accelerator pedal or a brake pedal which is included in the driving operator 80. For example, a joystick or a gesture recognition device can also be used for the steering operation and the accelerating/decelerating operation. Lane change control is, for example, ALC control for changing the lane of the host vehicle M from a host vehicle travel lane to a target neighboring lane by performing one or both of steering control and speed control of the host vehicle M. The lane change start switch 32 may receive information indicating one direction of the right and left sides in which the host vehicle M perform lane change along with an operation of starting the lane change. The lane change start switch 32 may be, for example, a mechanical switch such as a button or may be a graphical user interface (GUI) switch which is displayed on the display 34.

The HMI 30 may include an overtaking start switch, a following travel start switch, and a lane keeping start switch in addition to the lane change start switch 32. The overtaking start switch is, for example, a switch for causing the automated driving controller 100 to perform overtaking control for allowing the host vehicle M to overtake a preceding vehicle. The following travel start switch is a switch for causing the automated driving controller 100 to perform driving control for allowing the host vehicle M to follow a preceding vehicle regardless of an occupant's steering operation or accelerating/decelerating operation. The lane keeping start switch is a switch for causing the automated driving controller 100 to perform driving control for allowing the host vehicle M to keep a travel lane thereof regardless of an occupant's steering operation. The HMI 30 may include a switch for switching between start and end of automated driving.

For example, various types of display devices such as a liquid crystal display (LCD) and an organic electroluminescence (EL) display may be employed as the display 34. The display 34 may be, for example, a meter display that is provided in a part of an instrument panel facing a driver, a center display that is provided at the center of the instrument panel, or a head-up display (HUD). The HUD is, for example, a device that allows an occupant to visually recognize an image to overlap a view and, for example, allows an occupant to visually recognize a virtual image by projecting light including an image to a front windshield or a combiner. The display 34 may include, for example, an operation receiver that receives an occupant's operation such as a touch panel. The HMI 30 may include speakers, buzzers, a touch panel, and keys.

The vehicle sensor 40 includes a vehicle speed sensor that detects a speed of the host vehicle M, an acceleration sensor that detects acceleration, a yaw rate sensor that detects a yaw rate (for example, a rotational angular velocity around a vertical axis passing through the center of gravity of the host vehicle M), and a direction sensor that detects a direction of the host vehicle M. Results of detection from the vehicle sensor 40 are output to the automated driving controller 100.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies the position of the host vehicle M on the basis of signals received from GNSS satellites. The GNSS receiver 51 is an example of a “position information acquirer.” The position of the host vehicle M may be identified or corrected by an inertial navigation system (INS) using the output of the vehicle sensor 40. The navigation HMI 52 includes a display device, a speaker, a touch panel, and keys. The GNSS receiver 51 may be provided in the vehicle sensor 40. A whole or a part of the navigation HMI 52 may be shared by the HMI 30. For example, the route determiner 53 determines a route (hereinafter referred to as a route on a map) from the position of the host vehicle M identified by the GNSS receiver 51 (or an input arbitrary position) to a destination input by an occupant using the navigation HMI 52 with reference to the first map information 54. The first map information 54 is, for example, information in which road shapes are expressed by links indicating roads and nodes connected by the links. The first map information 54 may include point of interest (POI) information. The route on a map is output to the MPU 60. The navigation device 50 may perform guidance for a route using the navigation HMI 52 on the basis of the route on a map. The navigation device 50 may transmit a current position and a destination to a navigation server via the communication device 20 and acquire a route which is equivalent to the route on a map from the navigation server. The navigation device 50 outputs the determined route on a map to the MPU 60.

The MPU 60 includes, for example, a recommended lane determiner 61 and stores second map information 62 in a storage device such as an HDD or a flash memory. The recommended lane determiner 61 divides a route on a map supplied from the navigation device 50 into a plurality of blocks (for example, every 100 [m] in a vehicle travel direction) and determines a recommended lane for each block with reference to the second map information 62. The recommended lane determiner 61 determines in which lane from the leftmost the host vehicle is to travel. When there is a branching point in the route on a map, the recommended lane determiner 61 determines a recommended lane such that the host vehicle M can travel on a rational route for traveling to a branching destination.

The second map information 62 is map information with higher precision than the first map information 54. The second map information 62 includes, for example, the number of lanes, the types of road markings, and information on the centers of lanes or information on boundaries of lanes. The second map information 62 may include road information, traffic regulation information, address information (addresses and postal codes), facility information, parking lot information, and phone number information. The road information includes, for example, a radius of curvature (a curvature), a width, and a gradient of a road. The second map information 62 may be updated from time to time by causing the communication device 20 to communicate with another device. The first map information 54 and the second map information 62 may be integrated into map information. The map information may be stored in the storage 190.

The driving operator 80 includes, for example, a direction indicator lever 82 for operating a direction indicator 92. The driving operator 80 includes, for example, a steering wheel, an accelerator pedal, and a brake pedal. The driving operator 80 may include a shift lever, a deformed steering, a joystick, and other operators. For example, an operation detector that detects an amount of operation or execution of an operation which is performed on an operator by an occupant is attached to each operator of the driving operator 80. The operation detector detects, for example, a position of the direction indicator lever 82, a steering angle or a steering torque of the steering wheel, and an amount of depression of the accelerator pedal or the brake pedal. The operation detector outputs results of detection thereof to some or all of the automated driving controller 100, the travel driving force output device 200, the brake device 210, and the steering device 220.

The outside notifier 90 includes the direction indicator 92 which is an example of a direction indicator. The direction indicator 92 includes, for example, a light emitting part such as a lamp. The direction indicator 92 is provided at an arbitrary position on the host vehicle M (for example, front, rear, right, and left sides of the body of the host vehicle M) at which blinking of the light emitting part can be recognized from the surroundings of the host vehicle M. For example, the direction indicator 92 causes the light emitting part at a predetermined position to blink under the control of the HMI controller 180. For example, the outside notifier 90 may perform grille display or outside notification of blinking or turning on a vehicle lamp. The outside notifier 90 may include a speaker that outputs a voice and output a voice including information on future control based on automated driving or manual driving of the host vehicle M (for example, lane change) from the speaker.

The automated driving controller 100 performs automated driving on the basis of an instruction from an occupant or the like. The automated driving controller 100 may perform control for switching automated driving to manual driving in response to an occupant's predetermined operation. For example, the predetermined operation is an operation in which a steering angle or a steering torque of the steering wheel is equal to or greater than a threshold value or an operation in which an amount of depression of the accelerator pedal or the brake pedal is equal to or greater than a threshold value.

The automated driving controller 100 includes, for example, a first controller 120, a second controller 160, an HMI controller 180, and a storage 190. The first controller 120, the second controller 160, and the HMI controller 180 are realized, for example, by causing a hardware processor such as a central processing unit (CPU) to execute a program (software). Some or all of such elements may be realized in hardware (which includes circuitry) such as a large scale integration (LSI), an application specific integrated circuit (ASIC), a field-programmable gate array (FPGA), or a graphics processing unit (GPU) or may be realized in cooperation of software and hardware. The program may be stored in a storage device such as an HDD or a flash memory of the automated driving controller 100 (a storage device including a non-transitory storage medium) in advance, or may be installed in the storage device of the automated driving controller 100 by storing the program in a removable storage medium such as a DVD, a CD-ROM, or a memory card and attaching the removable storage medium (the non-transitory storage medium) to a drive device, a card slot, or the like.

The storage 190 may be realized by various storage devices described above, an electrically erasable programmable read only memory (EEPROM), a read only memory (ROM), a random access memory (RAM), or the like. For example, various types of information or programs associated with driving control in the embodiment are stored in the storage 190. Map information (for example, the first map information 54 and the second map information 62) may be stored in the storage 190.

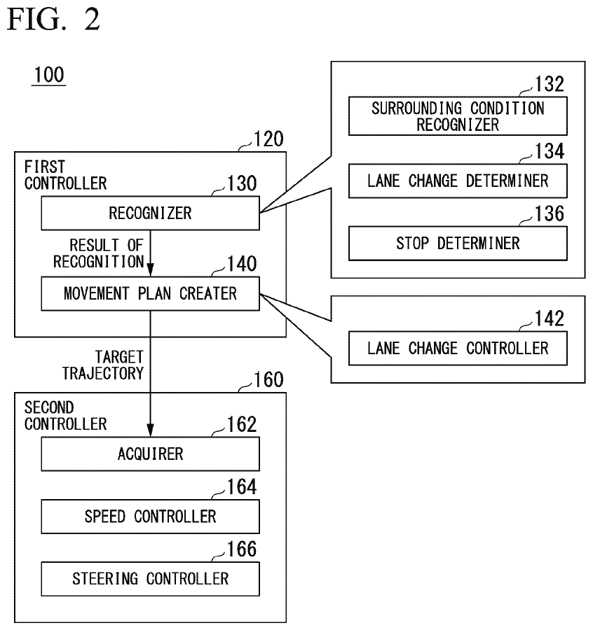

FIG. 2 is a diagram illustrating functional configurations of the first controller 120 and the second controller 160. The first controller 120 includes, for example, a recognizer 130 and a movement plan creator 140. The first controller 120 realizes, for example, a function based on artificial intelligence (AI) and a function based on a predetermined model in parallel. For example, a function of “recognizing a crossing” may be realized by performing recognition of a crossing based on deep learning or the like and recognition based on predetermined conditions (such as signals and road markings which can be pattern-matched) in parallel, scoring both recognitions, and comprehensively evaluating both recognitions. Accordingly, reliability of automated driving is secured. The first controller 120 performs control of automated driving of the host vehicle M, for example, on the basis of an instruction from the MPU 60 or the HMI controller 180 or an instruction from a terminal device 300.

The recognizer 130 includes, for example, a surrounding condition recognizer 132, a lane change determiner 134, and a stop determiner 136. The surrounding condition recognizer 132 recognizes surrounding conditions of the host vehicle M on the basis of information which is input from the camera 10, the radar device 12, and the LIDAR 14 via the object recognition device 16. For example, the surrounding condition recognizer 132 recognizes states such as a position, a speed, and acceleration of an object near the host vehicle M on the basis of the input information. For example, a position of an object is recognized as a position on an absolute coordinate system with a reference point (the center of gravity or the center of a drive shaft) of the host vehicle M as an origin, and is used for control. A position of an object may be represented as a representative point such as the center of gravity or a corner of the object or may be represented as a drawn area. When an object is a moving object such as another vehicle, “state” of the object may include an acceleration or a jerk of the object or a “moving state” (for example, whether lane change is being performed or whether lane change is going to be performed) thereof.

The surrounding condition recognizer 132 recognizes, for example, a travel lane or a neighboring lane of the host vehicle M. For example, the surrounding condition recognizer 132 recognizes the travel lane or the neighboring lane by comparing a pattern of road markings near the host vehicle M which are recognized from an image captured by the camera 10 with a pattern of road markings (for example, arrangement of solid lines and dotted lines) which are acquired from the second map information 62. The surrounding condition recognizer 132 is not limited to the road markings, but may recognize the travel lane or the neighboring lane by recognizing travel road boundaries (road boundaries) including road markings, edges of roadsides, curbstones, medians, and guard rails. In this recognition, the position of the host vehicle M acquired from the navigation device 50 or the result of processing from the INS may be considered. The surrounding condition recognizer 132 recognizes road signs, a radius of curvature (a curvature) of a road, a gradient of a road, a stop line, an obstacle, a red signal, a toll gate, an entrance/exit gate of a parking lot, a stop area, an alighting/boarding area, or other road events.

The surrounding condition recognizer 132 recognizes a position or a direction of the host vehicle M with respect to a travel lane at the time of recognition of the travel lane. The surrounding condition recognizer 132 may recognize, for example, separation of the reference point of the host vehicle M from the lane center and an angle of the travel direction of the host vehicle M with respect to a line formed by connecting the lane centers in the travel direction of the host vehicle M as the position and the direction of the host vehicle M relative to the travel lane. Instead, the surrounding condition recognizer 132 may recognize a position of the reference point of the host vehicle M relative to one side line of the travel lane (a road marking or a road boundary) or the like as the position of the host vehicle M relative to the travel lane.

The lane change determiner 134 determines whether lane change of the host vehicle M is executable on the basis of the result of recognition from the surrounding condition recognizer 132. The stop determiner 136 determines whether stopping conditions of the lane change are satisfied in a state in which is the lane change determiner 134 determines that the lane change of the host vehicle M is executable and lane change control is being performed in response to an occupant's request. Details of the functions of the lane change determiner 134 and the stop determiner 136 will be described later.

The movement plan creator 140 creates a movement plan with which the host vehicle M will travel by automated driving. The movement plan creator 140 creates, for example, a target trajectory in which the host vehicle M will travel autonomously (without requiring a driver's operation) in the future such that the host vehicle M travels in a recommended lane determined by the recommended lane determiner 61 in principle and copes with surrounding circumstances of the host vehicle M on the basis of the result of recognition from the recognizer 130 or the like. A target trajectory includes, for example, a speed element. For example, a target trajectory is expressed by sequentially arranging points (trajectory points) at which the host vehicle M is to arrive. Trajectory points are points at which the host vehicle M is to arrive at intervals of a predetermined traveling distance (for example, about several [m]) along a road, and a target speed and target acceleration at intervals of a predetermined sampling time (for example, about below the decimal point [sec]) are created as a part of a target trajectory in addition. Trajectory points may be positions at which the host vehicle M is to arrive at sampling times at every predetermined sampling time. In this case, information of a target speed or target acceleration is expressed by intervals between the trajectory points.

The movement plan creator 140 may set events of automated driving in creating a target trajectory. The events of automated driving include, for example, a constant-speed travel event in which the host vehicle M travels in the same lane at a constant speed, a following travel event in which the host vehicle M travels to follow another vehicle which is located within a predetermined distance (for example, within 100 [m]) in front of the host vehicle M and which is closest to the host vehicle M (hereinafter referred to as a preceding vehicle), a lane change event in which the host vehicle M changes its travel lane from a current lane to a neighboring lane, a branching event in which the host vehicle M moves to a destination lane at a branching point of a road, a merging event in which the host vehicle M moves to a main lane at a merging point, and a take-over event in which automated driving is ended and switched to manual driving. For example, the events may further include an overtaking event in which the host vehicle M temporarily changes its travel lane to a neighboring lane, overtakes a preceding vehicle in the neighboring lane, and changes the travel lane to the original lane again and an avoidance event in which at least one of braking and steering of the host vehicle M is performed to avoid an obstacle which is located in front of the host vehicle M.

For example, the movement plan creator 140 may change an event which is determined already for a current section to another event or set a new event for the current section on the basis of the surrounding conditions of the host vehicle M which are recognized by the surrounding condition recognizer 132 while the host vehicle M is traveling. The movement plan creator 140 may change an event which is set already for a current section to another event or set a new event for the current section on the basis of an occupant's operation of an onboard device. For example, the movement plan creator 140 may change an event which is set already for a current section to another event or set a new event for the current section when the occupant instructs to operate the direction indicator 92 using the lane change start switch 32 or the direction indicator lever 82. The movement plan creator 140 creates a target trajectory based on the set event. The movement plan creator 140 includes, for example, a lane change controller 142. The lane change controller 142 controls execution or stop of lane change (a lane change event) on the basis of the result of determination from the lane change determiner 134 or the stop determiner 136. Details of the function of the lane change controller 142 will be described later.

The second controller 160 controls the travel driving force output device 200, the brake device 210, and the steering device 220 such that the host vehicle M travels along a target trajectory created by the movement plan creator 140 as scheduled.

The second controller 160 includes, for example, an acquirer 162, a speed controller 164, and a steering controller 166. The acquirer 162 acquires information of a target trajectory (trajectory points) created by the movement plan creator 140 and stores the acquired information in a memory (not illustrated). The speed controller 164 controls the travel driving force output device 200 or the brake device 210 on the basis of a speed element accessory to the target trajectory stored in the memory. The steering controller 166 controls the steering device 220 on the basis of a curve state of the target trajectory stored in the memory. The processes of the speed controller 164 and the steering controller 166 are realized, for example, in combination of feed-forward control and feedback control. For example, the steering controller 166 performs control in combination of feed-forward control based on a radius of curvature of a road (or a curvature) in front of the host vehicle M and feedback control based on separation from the target trajectory.

Referring back to FIG. 1, the HMI controller 180 notifies an occupant of predetermined information using the HMI 30. The predetermined information includes information associated with travel of the host vehicle M such as information on the state of the host vehicle M or information on driving control thereof. The information on the state of the host vehicle M includes, for example, a speed, an engine rotation speed, and a shift position of the host vehicle M. The information on driving control includes, for example, information for inquiring about whether driving control based on automated driving (for example, lane change control) is being performed or whether automated driving is to be started and information on a driving control state based on automated driving. The predetermined information may also include information not associated with travel of the host vehicle M such as television programs or contents (for example, the movies) stored in a storage medium such as a DVD. The predetermined information may include, for example, information on a current position or a destination in automated driving and a residual amount of fuel of the host vehicle M. The HMI controller 180 may output the information received by the HMI 30 to the communication device 20, the navigation device 50, the first controller 120, and the like.

The HMI controller 180 may communicate with a terminal device which is used by a user of the host vehicle M or another external device via the communication device 20 and transmit the predetermined information to the terminal device or the other external device. The HMI controller 180 may output information acquired from the terminal device or the other external device to the HMI 30.

The HMI controller 180 receives operation details of the lane change start switch 32 or the direction indicator lever 82 which is operated by an occupant and causes the light emitting part of the direction indicator 92 to blink on the basis of the received operation details. The HMI controller 180 ends the blinking when a predetermined operation of the driving operator 80 is received or when predetermined behavior of the host vehicle M is recognized. The HMI controller 180 may control start and end of blinking of the light emitting part of the direction indicator 92 on the basis of a system request.

The travel driving force output device 200 outputs a travel driving force (a torque) for allowing the vehicle to travel to the driving wheels. The travel driving force output device 200 includes, for example, a combination of an internal combustion engine, an electric motor, and a transmission and an electronic control unit (ECU) that controls these elements. The ECU controls the elements on the basis of information input from the second controller 160 or information input from the accelerator pedal of the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second controller 160 or the information input from the brake pedal of the driving operator 80 such that a brake torque based on a braking operation is output to vehicle wheels. The brake device 210 may include a mechanism for transmitting a hydraulic pressure generated by an operation of the brake pedal to the cylinder via a master cylinder as a backup. The brake device 210 is not limited to the above-mentioned configuration, and may be an electronically controlled hydraulic brake device that controls an actuator on the basis of information input from the second controller 160 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the second controller 160 or the information input from the steering wheel of the driving operator 80 such that the direction of the turning wheels changes.

[Driving Control]

Driving control in this embodiment will be specifically described below. In the following description, several control patterns will be described with a focus on lane change control which is mainly performed in first driving control. The following control patterns may be applied to overtaking control or the like which is performed in the first driving control or may be applied to driving control in second driving control.

[First Control Pattern]

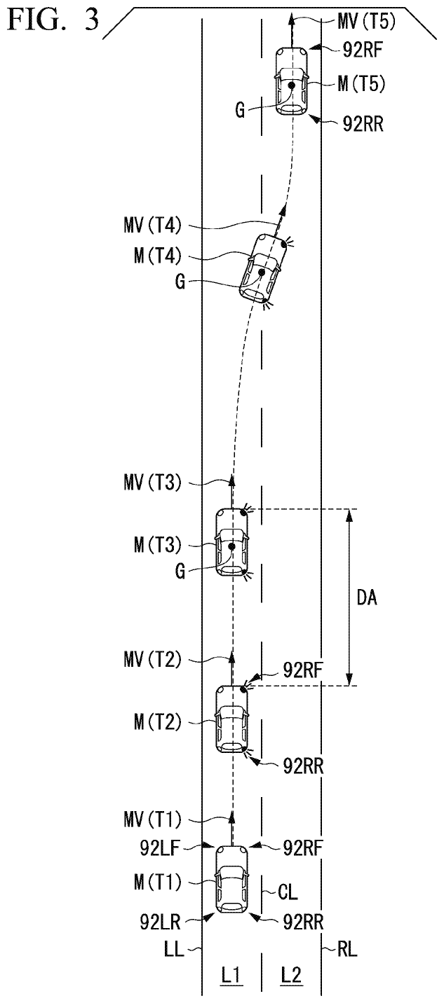

FIG. 3 is a diagram illustrating lane change control in a first control pattern. The first control pattern is a control pattern in which lane change is performed without satisfying the stopping conditions of lane change after having satisfied the execution conditions of lane change in lane change based on automated driving of the host vehicle M.

In the example illustrated in FIG. 3, two lanes L1 and L2 which can extend in the same direction are illustrated. The lane L1 is an example of a “host vehicle travel lane.” The lane L2 is an example of a “neighboring lane” which is adjacent to the lane L1. The lane L1 is a lane which is defined by lane markings LL and CL, and the lane L2 is a lane which is defined by lane markings CL and RL. In the example illustrated in FIG. 3, it is assumed that the host vehicle M travels in the lane L1 at a speed VM. Times T1 to T5 represent times at which the host vehicle M which is traveling reaches the corresponding points and it is assumed that the times T1 to T5 satisfy a relationship of “T1<T2<T3<T4<T5.” In the example illustrated in FIG. 3, the position of the host vehicle M at time T* is defined as host vehicle M(T*) and the speed thereof is defined as MV(T*). It is assumed that direction indicators 92LF and 92RF are provided on the right and left sides in the front of the body of the host vehicle M and direction indicators 92LR and 92RR are provided on the right and left sides in the back of the body. The same is true of the following description.

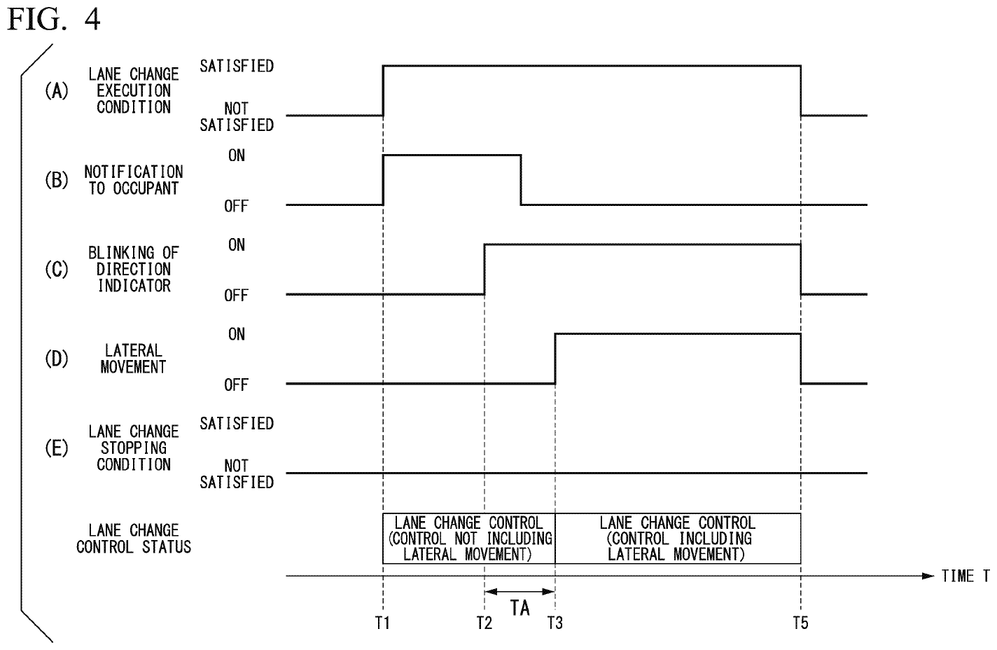

FIG. 4 is a diagram illustrating switching times of various devices or control associated with lane change control in the first control pattern. In the example illustrated in FIG. 4, switching times with the elapse of time in “(A) execution conditions of lane change being satisfied/not satisfied,” “(B) ON/OFF of notification of occupant,” “(C) ON/OFF of blinking of direction indicator 92,” “(D) ON/OFF of lateral movement control of lane change,” and “(E) stopping conditions of lane change being satisfied/not satisfied,” which are switching associated with lane change control, are illustrated. In the example illustrated in FIG. 4, statuses (execution states) of lane change control which are correlated with the switching times of various devices or control are illustrated.

The lane change determiner 134 determines whether lane change of the host vehicle M is executable on the basis of the results of recognition from the surrounding condition recognizer 132, map information, or the like. For example, the lane change determiner 134 may determine whether all of the following execution conditions of lane change are satisfied, determine that lane change is executable when all the execution conditions are satisfied, and determine that lane change is not executable when any one of the execution conditions is not satisfied.

Execution Condition 1: There are no obstacles (for example, another vehicle interfering with lane change) in the lane L2 which is a lane change destination.

Execution Condition 2: A road marking CL partitioning the lane which is a lane change destination and the host vehicle travel lane is not a road marking indicating prohibition of lane change (prohibition of crossing).

Execution Condition 3: The lane which is a lane change destination is recognized.

Execution Condition 4: A yaw rate which is detected by a yaw rate sensor included in the vehicle sensor 40 is less than a threshold value.

Execution Condition 5: A radius of curvature of a road on which the host vehicle is traveling is equal to or greater than a predetermined value

Execution Condition 6: The speed of the host vehicle is within a predetermined speed range.

The lane change determiner 134 determines whether lane change to the lane L2 is executable at a time at which it is determined that lane change to the lane L2 is necessary to travel to a destination set by the navigation device 50 or at a time at which a preceding vehicle of the host vehicle M has approached the host vehicle M (within a predetermined distance). In the examples illustrated in FIGS. 3 and 4, it is assumed that the lane change determiner 134 determines that lane change to the lane L2 is executable at time T1. When it is determined that lane change is executable, the HMI controller 180 notifies an occupant of information on lane change. For example, the HMI controller 180 generates information for inquiring about whether lane change is executable in a current situation of the host vehicle M and whether lane change is to be executed and outputs the generated information from the HMI 30.

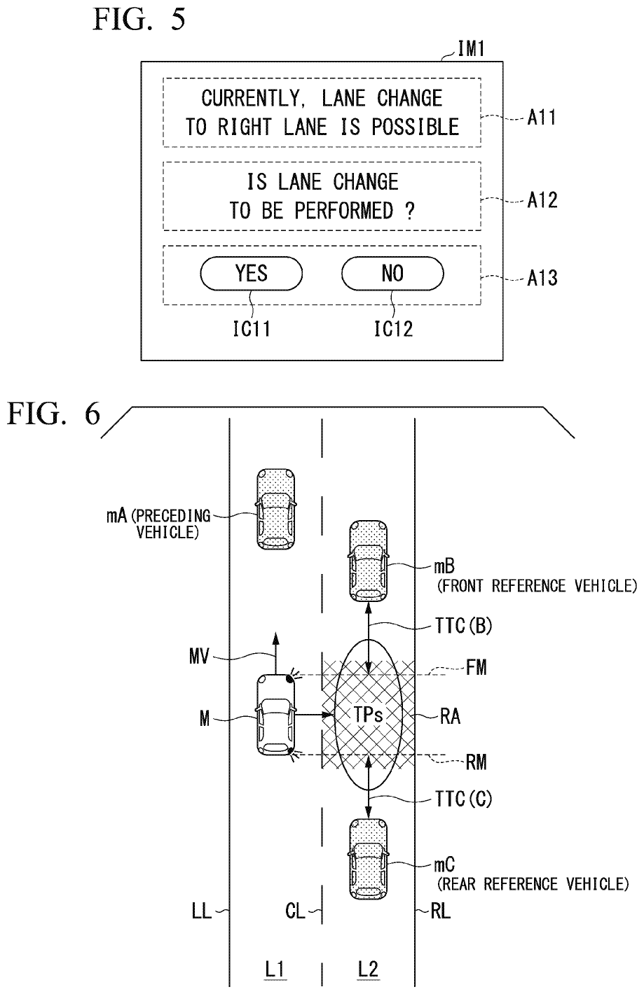

FIG. 5 is a diagram illustrating an example of an image IM1 which is output to the display 34 in the first control pattern. A display mode such as a layout or display details of the image IM1 is not limited to the following example. The same is true of the following description of images. The image IM1 illustrated in FIG. 5 includes a driving control information display area A11, an inquiry information display area A12, and a switch display area A13. For example, information on a driving situation of the host vehicle M is displayed in the driving control information display area A11. For example, the information on the driving situation includes information indicating that driving control such as ALC is executable. In the example illustrated in FIG. 5, text information such as “lane change to the right lane is currently executable.” is displayed in the driving control information display area A11.

For example, information for inquiring of an occupant about whether executable driving control which is correlated with the information displayed in the driving control information display area A11 is to be actually performed is displayed in the inquiry information display area A12. In the example illustrated in FIG. 5, text information “Is lane change to be performed?” is displayed in the inquiry information display area A12.

For example, a first icon IC11 and a second icon IC12 are displayed in the switch display area A13. The first icon IC11 is a GUI switch that receives permission of the inquiry information which is displayed in the inquiry information display area A12. The first icon IC11 is an example of the lane change start switch 32. The second icon IC12 is a GUI switch that receives prohibition of the inquiry information which is displayed in the inquiry information display area A12. In the example illustrated in FIG. 5, the HMI controller 180 considers that an instruction to execute lane change by automated driving is received when selection of the first icon IC11 is received, and considers that an instruction not to execute lane change by automated driving is received when selection of the second icon IC12 is received.

The HMI controller 180 may cause the image IM1 to include only information which is displayed in the driving control information display area A11. The HMI controller 180 may consider that an instruction to execute lane change by automated driving is received when operation of the direction indicator lever 82 or operation of the lane change start switch 32 which is a mechanical switch is received in a state in which the image IM1 is displayed on the display 34.

For example, the HMI controller 180 displays the image IM1 on the display 34 when the lane change by automated driving is executable, and ends display of the image IM1 when the lane change by automated driving becomes inexecutable. The HMI controller 180 may generate audio which is correlated with at least a part of the information displayed in the image IM1 and output the generated audio from a speaker of the HMI 30. The same is true of the following images.

Referring back to FIGS. 3 and 4, when an instruction to execute lane change by automated driving is received at time T2, the HMI controller 180 causes the direction indicators 92RF and 92RR indicating that lane change to a target neighboring lane (the lane L2 in FIG. 3) is executed to blink. The time at which the direction indicators 92RF and 92RR are turned on at time T2 may be arbitrarily set, for example, by the vehicle system 1 side.

When an instruction to execute lane change by automated driving is received, the lane change controller 142 executes lane change from the lane L1 to the lane L2. Specifically, the lane change controller 142 sets a target position after the lane change to the lane L2 has been executed, and performs movement in the lateral direction (in the direction to the lane L2) (lateral movement) with respect to the extending direction of the lanes L1 and L2 to move the host vehicle M to the set target position.

FIG. 6 is a diagram schematically illustrating an example in which a lane change target position TPs is set in the lane L2. For example, when an instruction to execute lane change to the lane L2 is received by operating the direction indicator lever 82, the lane change controller 142 selects two arbitrary vehicles (for example, two vehicles relatively close to the host vehicle M) out of nearby vehicles located in the lane L2, and sets a lane change target position TPs between the selected two nearby vehicles. For example, the lane change target position TPs is set to the center of the lane L2. In the following description, the nearby vehicle located immediately before the set lane change target position TPs is referred to as a “front reference vehicle MB” and the nearby vehicle located immediately after the lane change target position TPs is referred to as a “rear reference vehicle MC.” The lane change target position TPs is a relative position based on a positional relationship between the host vehicle M and the front reference vehicle MB and the rear reference vehicle MC.

After the lane change target position TPs has been set, the lane change controller 142 sets a restrictive area RA illustrated in the drawing on the basis of the set position of the lane change target position TPs. For example, the lane change controller 142 projects the host vehicle M onto the lane L2 which is a lane change destination and sets an area with a slight margin distance before and after the projected host vehicle M as the restrictive area RA. The restrictive area RA is set to an area which extends from one lane marking CL defining the lane L2 to the other lane marking RL.

When a part of a nearby vehicle is not located in the set restrictive area RA, a time-to-collision TTC(B) between the host vehicle M and the front reference vehicle MB is greater than a threshold value Th(B), and a time-to-collision TTC(C) between the host vehicle M and the rear reference vehicle MC is greater than a threshold value Th(C), the lane change controller 142 sets up the set target position TPs. The description “a part of a nearby vehicle is not located in the restrictive area RA” means, for example, that the restrictive area RA does not overlap an area indicating the nearby vehicle in a top view. The time-to-collision TTC(B) is derived, for example, by dividing a distance between an extension line FM obtained by virtually extending the front end of the host vehicle M to the lane L2 and the front reference vehicle MB by a relative speed between the host vehicle M and the front reference vehicle MB. The time-to-collision TTC(C) is derived, for example, by dividing a distance between an extension line RM obtained by virtually extending the rear end of the host vehicle M to the lane L2 and the rear reference vehicle MC by a relative speed between the host vehicle M and the rear reference vehicle MC. The threshold values Th(B) and Th(C) may be the same value or different values.

When a part of a nearby vehicle is located in the set restrictive area RA, the time-to-collision TTC(B) is equal to or less than the threshold value Th(B), or the time-to-collision TTC(C) is equal to or less than the threshold value Th(C), the lane change controller 142 selects two other vehicles out of nearby vehicles located in the lane L2 and sets up a target position by newly setting the target position TPs. In this case, until the target position TPs is set, the lane change controller 142 may control the speed of the host vehicle M such that the current speed is maintained or accelerate/decelerate the host vehicle M such that the host vehicle M moves to the side of the target position TPs.

The lane change controller 142 sets the target position TPs on the basis of the speed MV of the host vehicle M, the road shape, or the like when no nearby vehicles are located in the lane L2, and sets the lane change target position TPs to an arbitrary position in front of or behind a nearby vehicle when only one nearby vehicle is located in the lane L2.

[FIG. 4: Regular Lane Change]

The lane change controller 142 generates a target trajectory along which the host vehicle moves to the target position TPs. In this case, the lane change controller 142 generates a target trajectory in which lateral movement for lane change is not performed until the host vehicle travels a predetermined distance DA from a point at which blinking of the direction indicators 92RF and 92RR has been started or until a predetermined time TA elapses after blinking of the direction indicators 92RF and 92RR has been started as illustrated in FIG. 4 and then lateral movement to the lane L2 is performed. The predetermined distance DA is an example of a “third predetermined distance.” The predetermined distance DA is, for example, in the range of about 50 [m] to 200 [m]. The predetermined time TA is an example of a “third predetermined time.” The third predetermined time is a time other than a first predetermined time and a second predetermined time. The predetermined time TA is determined, for example, on the basis of the rules. For example, the predetermined time TA is in the range of about 3 [sec] to 5 [sec]. By maintaining traveling in the lane L1 until the predetermined distance DA or the predetermined time TA from blinking of the direction indicators 92RF and 92RR, outside of the host vehicle (for example, a nearby vehicle) can be made to easily recognize that the host vehicle M is about to change lane and a lane change destination before lateral movement for lane change is started.

The lane change controller 142 starts lane change including lateral movement to the lane L2 at time T3, performs travel including lateral movement at time T4, and controls travel of the host vehicle M such that a reference position (for example, the center of gravity G) of the host vehicle M is positioned at the center (a target position) of the lane L2 at time T5. When travel control including lateral movement is completed at time T5, the lane change controller 142 ends blinking of the direction indicators 92RF and 92RR and ends the lane change control. When the lane change to the lane L2 ends, the host vehicle M travels in the lane L2.

[Second Control Pattern]

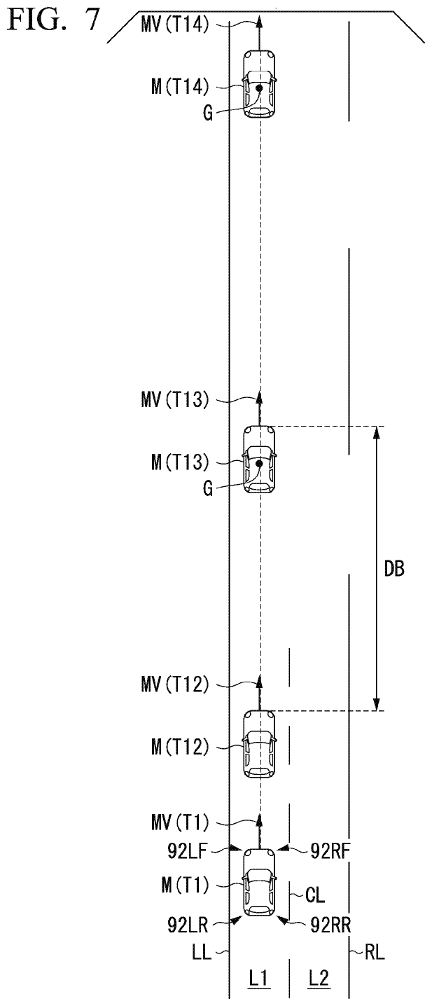

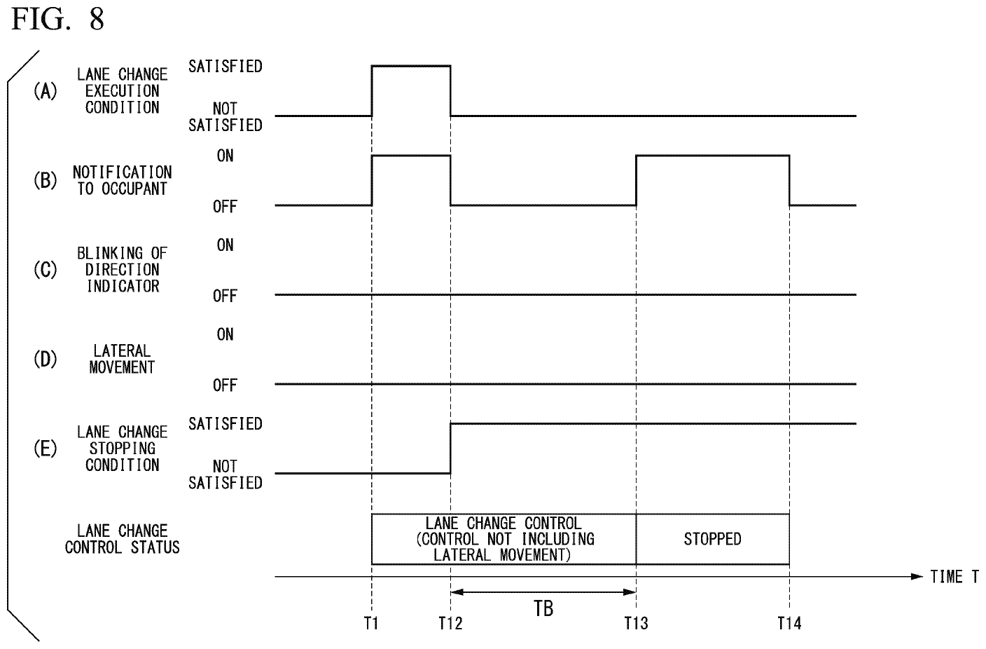

FIG. 7 is a diagram illustrating lane change control in a second control pattern. FIG. 8 is a diagram illustrating switching times of various types of devices or control which are associated with lane change control in the second control pattern. In the following description, parts different from in the first control pattern will be mainly described. The second control pattern is a control pattern which is used when the stopping conditions of lane change have been satisfied at the time of starting of lane change in comparison with the first control pattern. The time of starting of lane change is, for example, a period before lateral movement of the host vehicle M to a lane change destination is performed and after a lane change instruction has been received. The second control pattern represents a control pattern in a period before blinking of the direction indicators is started at the time of starting.

In FIGS. 7 and 8, Times T1 and T12 to T14 represent times at which the host vehicle M which is traveling reaches the corresponding points and it is assumed that times T1 and T12 to T14 satisfy a relationship of “T1<T12<T13<T14.”

At time T1 in FIGS. 7 and 8, it is assumed that lane change is determined to be executable by the lane change determiner 134. When it is determined that lane change is executable, the HMI controller 180 notifies an occupant of information on lane change. For example, the stop determiner 136 determines whether at least one of stopping conditions of lane change described below is satisfied on the basis of the result of recognition from the surrounding condition recognizer 132, map information, or the like in a state in which lane change is determined to be executable by the lane change determiner 134 and lane change control is being performed. Then, the stop determiner 136 determines that the stopping conditions of lane change are satisfied when at least one is satisfied, and determines that the stopping conditions are not satisfied when no conditions are satisfied.

Stopping Condition 1: There is an obstacle (for example, another vehicle interfering with lane change) in the lane L2 which is a lane change destination.

Stopping Condition 2: The lane which is a lane change destination is not recognized.

Stopping Condition 3: A radius of curvature of a road on which the host vehicle is traveling is less than a predetermined value

Stopping Condition 4: The speed of the host vehicle exceeds a predetermined speed range.

In the examples illustrated in FIGS. 7 and 8, since the line CL or RL of a lane change destination is not recognized at time T12, it is assumed that the stop determiner 136 determines that the lane L2 satisfies the stopping conditions. In the second control pattern, at time T12, the direction indicators 92 are not blinking and thus the lane change destination of the host vehicle M is not notified to the outside. In this case, until a predetermined time TB elapses after the stopping conditions of lane change have been satisfied or until the host vehicle travels a predetermined distance DB from a point at which the stopping conditions of lane change have been satisfied, the lane change controller 142 causes the host vehicle M to keep traveling in the travel lane while continuously performing lane change control not including lateral movement. The predetermined time TB is an example of a “first predetermined time.” The predetermined time TB is, for example, in the range of about 8 [sec] to 15 [sec]. The predetermined distance DB is an example of a “first predetermined distance.” The predetermined distance DB is, for example, in the range of about 100 [m] to 300 [m].

The lane change controller 142 sets up that lane change control is to be stopped when the stopping conditions of lane change are continuously satisfied even after the predetermined time TB has elapsed or the host vehicle has traveled the second predetermined distance DB. The HMI controller 180 generates an image indicating that the execution conditions of lane change are not satisfied, and displays the generated image on the display 34.

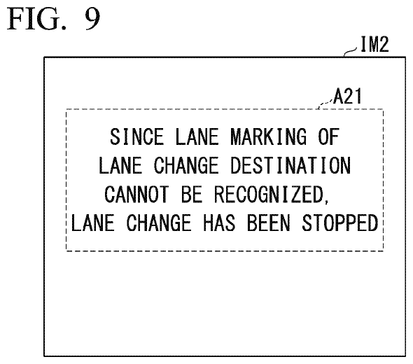

FIG. 9 is a diagram illustrating an example of an image IM2 which is output to the display 34 in the second control pattern. The image IM2 illustrated in FIG. 9 includes, for example, a driving control information display area A21. For example, information on a driving situation of the host vehicle M is displayed in the driving control information display area A21. For example, the information on the driving situation includes information indicating that lane change control is stopped. A reason for stopping of lane change control may be displayed in the driving control information display area A21. In the example illustrated in FIG. 9, text information “since lane markings of a lane change destination cannot be recognized, lane change has been stopped.” is displayed in the driving control information display area A21. The HMI controller 180 displays the image IM2 on the display 34 for a predetermined time.

In this way, it is possible to more clearly notify an occupant that lane change control has stopped after lane change has been executable and before lateral movement of lane change control is performed. Accordingly, it is possible to more appropriately allow an occupant to easily understand a driving situation.

In the second control pattern, when the stopping conditions are not satisfied (central conditions are not satisfied) after the stopping conditions of lane change have been satisfied and before the predetermined time TB elapses or before the host vehicle M travels the predetermined distance DB, the lane change controller 142 notifies that lane change to the lane L2 is to be performed by causing the direction indicators 92 to blink and then starts lane change including lateral movement to the lane L2. Accordingly, when the stopping conditions are not satisfied, it is possible to smoothly perform lane change without receiving a lane change instruction again from an occupant.

[Third Control Pattern]

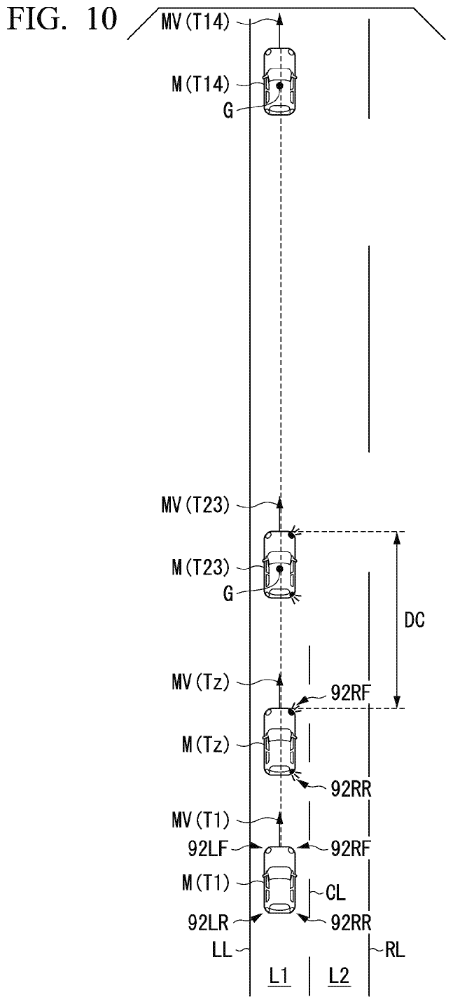

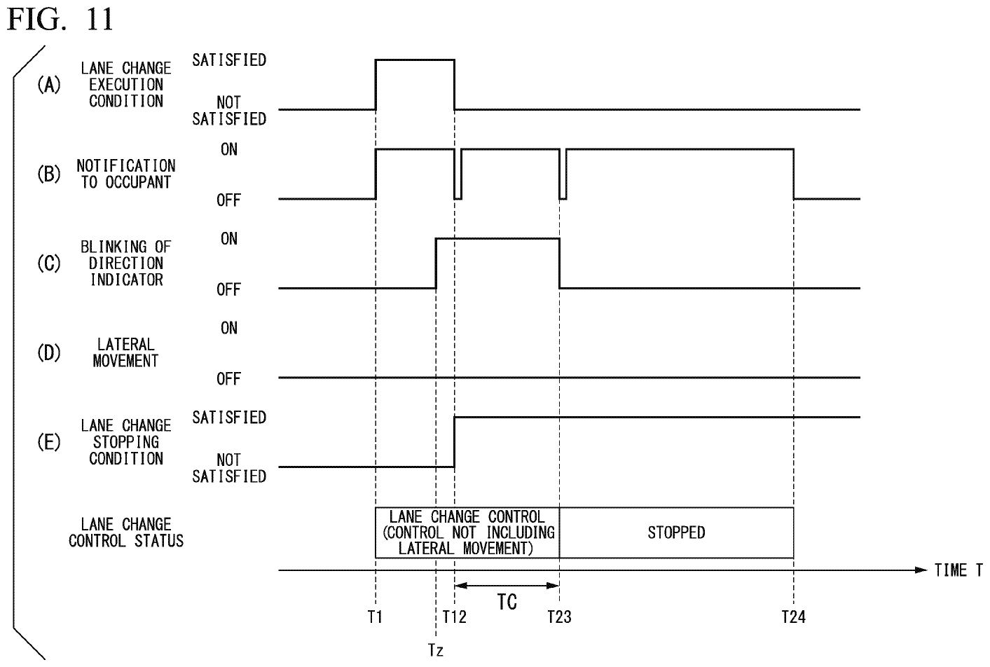

FIG. 10 is a diagram illustrating lane change control in a third control pattern. FIG. 11 is a diagram illustrating switching times of various types of devices or control which are associated with lane change control in the third control pattern. In the following description, parts different from in the second control pattern will be mainly described. The third control pattern is different from the second control pattern, in that blinking of the direction indicators based on a lane change instruction from an occupant is started at time Tz prior to time T12 at which the stopping conditions of lane change are satisfied. Accordingly, a control pattern in a period in which blinking of the direction indicators is started at the time of starting of lane change will be mainly described below.

In FIGS. 10 and 11, Times T1, Tz, T12, T23, and T24 represent times at which the host vehicle M which is traveling reaches the corresponding points and it is assumed that times T1, Tz, T12, T23, and T24 satisfy a relationship of “T1<Tz<T12<T23<T24.”

At time T12 in FIGS. 10 and 11, since the line CL or RL of a lane change destination is not recognized, it is assumed that the stop determiner 136 determines that the lane L2 satisfies the stopping conditions. In the third control pattern, at time T12, the direction indicators 92 are blinking. Accordingly, when the stopping conditions of lane change have been satisfied or until a predetermined time TC elapses after blinking of the direction indicators 92 has been started, the lane change controller 142 causes the host vehicle M to keep traveling in the travel lane while continuously performing lane change control not including lateral movement. The predetermined time TC is an example of a “second predetermined time.” The predetermined time TC is a time which is shorter than the predetermined time TB and is, for example, in the range of about 1 [sec] to 3 [sec]. When the stopping conditions of lane change have been satisfied or until the host vehicle travels a predetermined distance DC after blinking of the direction indicators 92 has been started, the lane change controller 142 causes the host vehicle M to keep traveling in the travel lane L1 while continuously performing lane change control not including lateral movement. The predetermined distance DC is an example of a “third predetermined distance.” The predetermined distance DC is a distance which is shorter than the predetermined distance DB and is, for example, in the range of about 10 [m] to 100 [m].

As in the second and third control patterns, when the direction indicators 92 are blinking, the future behavior of the host vehicle M can be earlier set up and can be notified to the outside by decreasing a duration time or a duration distance of lane change control after the stopping conditions have been satisfied in comparison with a case in which the direction indicators 92 do not blink. Accordingly, it is possible to realize a more appropriate traffic flow including nearby vehicles.

In the third control pattern, when the stopping conditions of lane change are continuously satisfied at time T23 at which the predetermined time TC elapses or after the host vehicle travels the predetermined distance DC, the lane change controller 142 stops the lane change. The lane change controller 142 stops blinking of the direction indicators 92 at the time (time T23) at which the lane change is stopped. Accordingly, it is possible to allow an occupant to easily understand that the lane change is stopped. The HMI controller 180 generates an image IM2 indicating that the lane change has been stopped and displays the generated image IM2 on the display 34.

In the third control pattern, when lane change is continuously performed and control including lateral movement is waited for in a period from time T12 to time T23, the HMI controller 180 may generate an image including information indicating that lane change control is being waited for and display the generated image on the display 34.

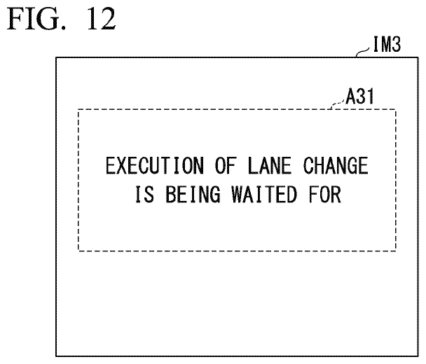

FIG. 12 is a diagram illustrating an example of an image IM3 indicating that execution of lane change is being waited for in the third control pattern. The image IM3 illustrated in FIG. 12 includes, for example, a driving control information display area A31. For example, information indicating that the stopping conditions are satisfied and lane change control is being continuously performed for a predetermined time is displayed in the driving control information display area A31. In the example illustrated in FIG. 12, text information “execution of lane change is being waited for.” is displayed in the driving control information display area A31. The image IM3 may be displayed in a period from time Tz to time T23 instead of the period from time T12 to time T23. In this way, by more clearly notifying an occupant of an execution state of driving control, it is possible to more appropriately allow the occupant to easily understand the driving situation of the host vehicle M.

In the third control pattern, when the stopping conditions are not satisfied after the stopping conditions of lane change have been satisfied and before the predetermined time TC elapses or before the host vehicle travels the predetermined distance DC, the lane change controller 142 starts lane change including lateral movement to the lane L2. Accordingly, when the stopping conditions are not satisfied, it is possible to smoothly perform lane change without receiving a lane change instruction again from an occupant.

[Fourth Control Pattern]

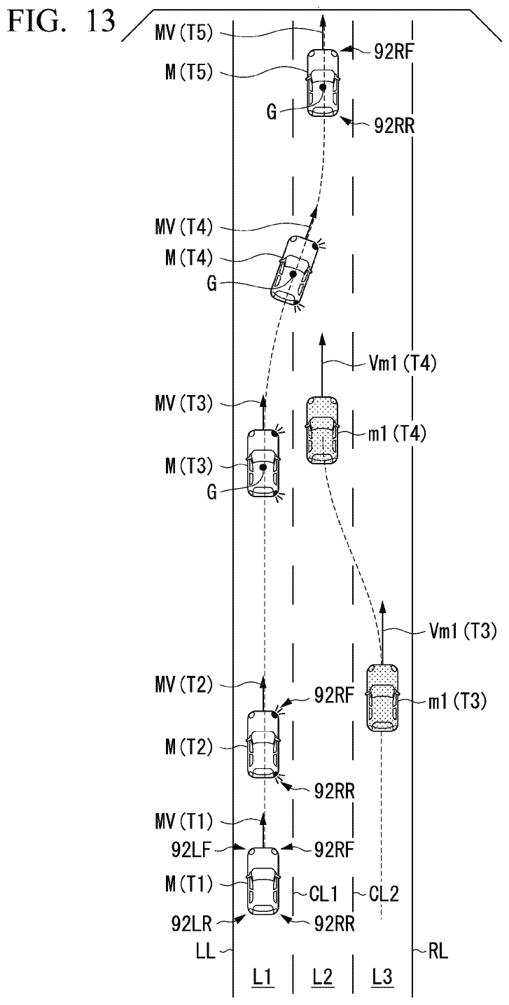

FIG. 13 is a diagram illustrating lane change control in a fourth control pattern. In the example illustrated in FIG. 13, a road including a lane L3 which extends in the same direction as lanes L1 and L2 is illustrated. The lane L1 is defined by lane markings LL and CL1, the lane L2 is defined by lane markings CL1 and CL2, and the lane L3 is defined by lane markings CL2 and RL. In the example illustrated in FIG. 13, it is assumed that times T1 to T5 satisfy the same relationship as in the first control pattern. It is also assumed that the host vehicle M travels in the lane L1 at a speed VM and another vehicle ml travels in the lane L3 at a speed Vm1 until time T3.

The fourth control pattern indicates a control pattern when the stopping conditions are satisfied in a state in which lateral movement of the host vehicle M to the lane L2 is being performed by lane change control. In the example illustrated in FIG. 13, it is assumed that the other vehicle ml changes its lane to the lane L2 which is a lane change destination of the host vehicle M and approaches the lane L2 while the host vehicle M is laterally moving and thus the stopping conditions of lane change of the host vehicle M are satisfied.

In this case, the lane change controller 142 performs driving control of the host vehicle M on the basis of the position of the host vehicle M on a road (the lanes L1 and L2) when the stopping conditions are satisfied. For example, when the reference position (for example, the center of gravity G or the tip) of the host vehicle M when the stopping conditions are satisfied while laterally moving (for example, at time T4) is located in the lane L2 over the lane marking CL1 partitioning the lanes L1 and L2, the lane change controller 142 continuously performs lane change (lateral movement) to the lane L2. When the reference position of the host vehicle M has not crossed the lane marking CL1 and is located in the lane L1, the lane change controller 142 performs travel control for positioning the reference position of the host vehicle M at the center of the lane L1 (travel control for returning to the original lane). Accordingly, it is possible to perform driving control with a decreased probability of contact with another vehicle on the basis of the situation of the host vehicle M.

### Modified Examples

For example, the lane change controller 142 may change one or both of the predetermined times TB and TC on the basis of the speed VM of the host vehicle M. In this case, the lane change controller 142 changes the predetermined time TB or TC to increase as the speed increases.

The lane change controller 142 may change one or both of the predetermined times TB and TC on the basis of a road type or road conditions in which the host vehicle M is traveling instead of (or in addition to) the speed VM of the host vehicle M. The road type is, for example, a type such as an expressway, a toll road, or a general road. The road conditions are, for example, a degree of congestion, the number of lanes, a radius of curvature of a road, and a gradient. For example, when the host vehicle is traveling on an expressway, the lane change controller 142 changes one or both of the predetermined times TB and TC to be longer than that of a toll road and a general road. The lane change controller 142 changes one or both of the predetermined times TB and TC to increase as the degree of congestion of a road increases.

The lane change controller 142 may change one or both of the predetermined times TB and TC on the basis of details of the stopping conditions of lane change instead of (or in addition to) the speed VM of the host vehicle M and the road type and the road conditions of a road on which the host vehicle M travels. For example, the lane change controller 142 sets the predetermined times TB and TC which are correlated with Stopping Conditions 1 to 4 described above and continues to perform lane change on the basis of the predetermined time TB or TC which is set in the stopping conditions which are satisfied.

The lane change controller 142 may change one or both of the predetermined distances DB and DC on the basis of at least one of the speed VM of the host vehicle M, the road type, the road conditions, and details of the stopping conditions. In this case, the lane change controller 142 changes the predetermined distance DB or DC to increase as the speed increases or changes the predetermined distance DB or DC to decrease as the degree of congestion increases.

The lane change controller 142 may change the predetermined time TA or the predetermined distance DA on the basis of at least one of the speed VM of the host vehicle M, the road type, the road conditions, and details of the stopping conditions. In this way, by changing the predetermined time or the predetermined distance in which lane change is continuously performed on the basis of the traveling state or the surrounding conditions of the host vehicle M and details of the stopping conditions, it is possible to realize more appropriate driving control.

[Process Flow]

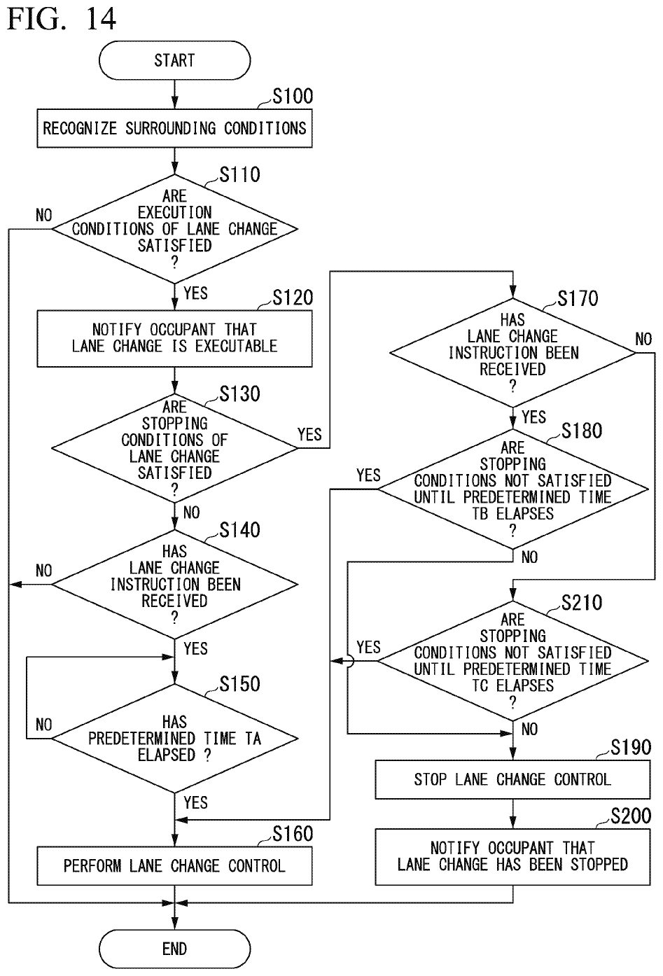

FIG. 14 is a flowchart illustrating an example of a process flow which is performed by the automated driving controller 100 according to the embodiment. In the following description, a process flow of driving control including the above-mentioned lane change control will be mainly described. The example illustrated in FIG. 14 is repeatedly performed while automated driving is being performed by the automated driving controller 100.

In the process flow illustrated in FIG. 14, the surrounding condition recognizer 132 recognizes the surrounding conditions of the host vehicle M (Step S100). Then, the lane change determiner 134 determines whether execution conditions of lane change have been satisfied on the basis of the result of recognition (Step S110). When it is determined that the execution conditions of lane change have been satisfied, the HMI controller 180 notifies an occupant that lane change is executable (Step S120). Then, the stop determiner 136 determines whether the stopping conditions of lane change have been satisfied (Step S130). When it is determined that the stopping conditions have not been satisfied, the lane change controller 142 determines whether a lane change instruction from an occupant has been received (Step S140). When it is determined that a lane change instruction from an occupant has been received, the lane change controller 142 determines whether a predetermined time TA has elapsed and determines whether the predetermined time TA has elapsed after the lane change instruction has been received (Step S150). When it is determined that the predetermined time TA has not elapsed, the process flow waits until the predetermined time TA elapses. When it is determined that the predetermined time TA has elapsed, the lane change controller 142 performs lane change control to a target lane change destination (Step S160). Details of the lane change execution process of Step S160 will be described later.

When it is determined in Step S130 that the stopping conditions of lane change have been satisfied, the lane change controller 142 determines whether a lane change instruction from an occupant has been received (Step S170). When it is determined that a lane change instruction has been received, the lane change controller 142 determines whether the stopping conditions are not satisfied until the predetermined time TB elapses (Step S180). When it is determined that the stopping are not satisfied until the predetermined time TB elapses, the lane change controller 142 performs the process of Step S160. When it is determined that the stopping conditions are satisfied until the predetermined time TB elapses, the lane change controller 142 stops the lane change control (Step S190). Then, the HMI controller 180 notifies an occupant that the lane change has been stopped (Step S200).

When it is determined in Step S170 that a lane change instruction has not been received, the lane change controller 142 determines whether the stopping conditions are not satisfied until the predetermined time TC elapses (Step S210). The lane change controller 142 performs the process of Step S160 when it is determined that the stopping conditions are not satisfied, and performs the processes of Step S190 and steps subsequent thereto when it is determined that the stopping conditions are satisfied. Then, the process flow of the flowchart ends. When it is determined in Step S110 that the execution conditions of lane change have not been satisfied or when it is determined in Step S140 that a lane change instruction has not been received, the process flow of the flowchart ends.

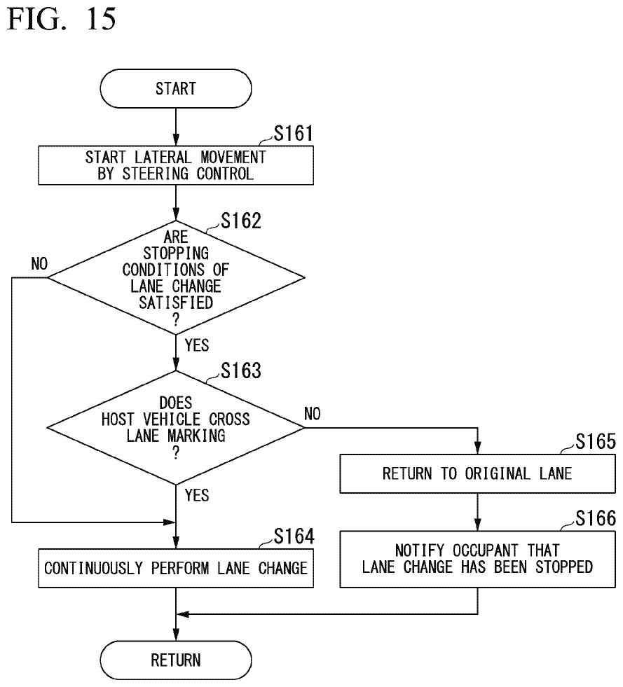

FIG. 15 is a flowchart illustrating an example of a process flow of a lane change execution process of Step S160. In the example illustrated in FIG. 15, the lane change controller 142 starts lateral movement by steering control of the host vehicle M (Step S161). Then, the stop determiner 136 determines whether the stopping conditions of lane change have been satisfied (Step S162). When it is determined that the stopping conditions of lane change have been satisfied, the lane change controller 142 determines whether the reference point of the host vehicle M crosses a lane marking which partitions the travel lane (for example, the lane L1) and the lane which is a target lane change destination (for example, the lane L2) (Step S163). When it is determined that the reference point crosses the lane marking or when it is determined in Step S162 that the stopping conditions of lane change have not been satisfied, the lane change controller 142 continuously performs the lane change (Step S164). When it is determined in Step S163 that the reference point does not cross the lane marking, the lane change controller 142 performs driving control such that the host vehicle returns to the original lane (the lane L1) (Step S165). Then, the HMI controller 180 notifies an occupant of information indicating that the lane change has been stopped (Step S166). Then, the process flow of the flowchart ends. In the above-mentioned processes, the predetermined distances DA, DB, and DC may be used instead of the predetermined times TA, TB, and TC.

According to the above embodiment, for example, the automated driving controller 100 includes: the recognizer 130 configured to recognize surrounding conditions of a host vehicle M; the driving controller (the first controller 120 and the second controller 160) configured to perform driving control for controlling one or both of speed and steering of the host vehicle M on the basis of the surrounding conditions recognized by the recognizer 130; and the outside notifier 90 configured to notify an outside of the host vehicle M that the host vehicle M will change a travel lane of the host vehicle M. The driving controller is configured to change a time or a distance until stop of driving control of lane change from a host vehicle travel lane in which the host vehicle M is traveling to a neighboring lane is set up depending on whether the outside of the host vehicle M is notified of a lane change destination by the outside notifier 90 when stopping conditions of the lane change from the host vehicle travel lane to a neighboring lane are satisfied at the time of starting of driving control for performing the lane change from the host vehicle travel lane to the neighboring lane. Accordingly, it is possible to perform more appropriate driving control.

Specifically, according to the embodiment, in execution of driving control of lane change or the like, it is possible to perform more appropriate driving control on the basis of the traveling state or the surrounding conditions of the host vehicle M by changing the time at which lane change is set up or stopped depending on the time at which the stopping conditions are satisfied after the execution conditions of the driving control have been satisfied. According to the embodiment, even when the stopping conditions are satisfied, it is possible to curb repeated execution of an instruction to perform driving control and stop control by maintaining the execution state of the driving control for a predetermined time.

[Hardware Configuration]

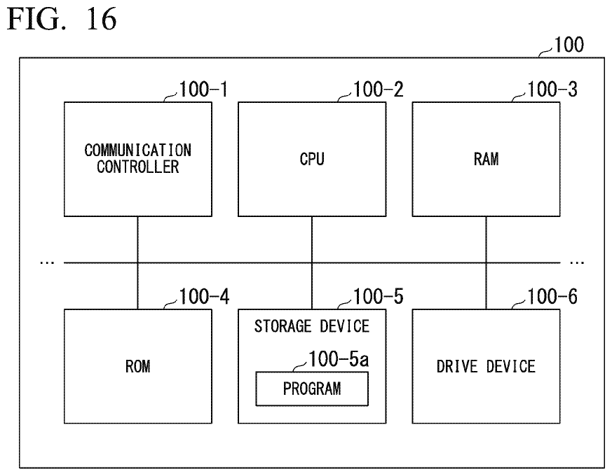

FIG. 16 is a diagram illustrating an example of a hardware configuration of the automated driving controller 100 according to the embodiment. As illustrated in the drawing, a computer of the automated driving controller 100 has a configuration in which a communication controller 100-1, a CPU 100-2, a random access memory (RAM) 100-3 that is used as a work memory, a read only memory (ROM) 100-4 that stores a booting program or the like, a storage device 100-5 such as a flash memory or a hard disk drive (HDD), a drive device 100-6, and the like are connected to each other via an internal bus or a dedicated communication line. The communication controller 100-1 communicates with elements other than the automated driving controller 100. A portable storage medium (for example, a non-transitory computer-readable storage medium) such as an optical disc is attached to the drive device 100-6. A program 100-5a which is executed by the CPU 100-2 is stored in the storage device 100-5. This program is loaded into the RAM 100-3 by a direct memory access (DMA) controller (not illustrated) or the like and is executed by the CPU 100-2. The program 100-5a which is referred to by the CPU 100-2 may be stored in a portable storage medium that is attached to the drive device 100-6 or may be downloaded from another device via a network. Accordingly, some or all of the constituent units of the automated driving controller 100 are realized.

The above-mentioned embodiment can also be expressed as follows:

A vehicle control device including:

a storage device that stores a program; and

a hardware processor,

wherein the hardware processor is configured to perform: by executing the program stored in the storage device,

recognizing surrounding conditions of a vehicle;

controlling one or both of speed and steering of the host vehicle on the basis of the recognized surrounding conditions;

causing an outside notifier to notify an outside of the host vehicle of a lane change destination of the host vehicle; and

changing a time or a distance until lane change from a host vehicle travel lane in which the host vehicle is traveling to a neighboring lane which is adjacent to the host vehicle travel lane is stopped depending on whether the outside of the host vehicle is notified of the lane change destination by the outside notifier when stopping conditions of the lane change are satisfied at the time of starting of the lane change.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer configured to recognize surrounding conditions of a host vehicle;
a driving controller configured to control one or both of speed and steering of the host vehicle on the basis of the surrounding conditions recognized by the recognizer; and
an outside notifier configured to notify an outside of the host vehicle of a lane change destination of the host vehicle,
wherein the driving controller is configured to change a time or a distance until lane change from a host vehicle travel lane in which the host vehicle is traveling to a neighboring lane which is adjacent to the host vehicle travel lane is stopped depending on whether the outside of the host vehicle is notified of the lane change destination by the outside notifier when stopping conditions of the lane change are satisfied at the time of starting of the lane change.

2. The vehicle control device according to claim 1, wherein the driving controller is configured, at the time of starting of the lane change, to stop the lane change when the outside of the host vehicle is not notified of the lane change destination by the outside notifier and a first predetermined time has elapsed after the stopping conditions have been satisfied, and to stop the lane change when the outside of the host vehicle is notified of the lane change destination by the outside notifier and a second predetermined time which is shorter than the first predetermined time has elapsed.

3. The vehicle control device according to claim 2, wherein the driving controller is configured to change one or both of the first predetermined time and the second predetermined time on the basis of the speed of the host vehicle.

4. The vehicle control device according to claim 2, wherein the driving controller is configured to change one or both of the first predetermined time and the second predetermined time on the basis of a road type or road conditions in which the host vehicle is traveling.

5. The vehicle control device according to claim 2, wherein the driving controller is configured to change one or both of the first predetermined time and the second predetermined time on the basis of details of the stopping conditions for stopping the lane change.

6. The vehicle control device according to claim 1, further comprising an inside notifier configured to notify an occupant of the host vehicle when the lane change of the host vehicle is executable or when the lane change of the host vehicle is stopped.

7. The vehicle control device according to claim 2, wherein the driving controller is configured to perform the lane change including lateral movement to the neighboring lane when a third predetermined time other than the first predetermined time and the second predetermined time has elapsed or the host vehicle has traveled a third predetermined distance after the outside of the host vehicle has been notified of the lane change destination by the outside notifier.

8. The vehicle control device according to claim 1, wherein the driving controller is configured to determine whether the lane change is to be performed on the basis of a reference position of the host vehicle relative to the host vehicle travel lane and the neighboring lane when the stopping conditions are satisfied in a state in which the lane change including lateral movement to the neighboring lane is being performed and to continuously perform the lane change to the neighboring lane when the reference position of the host vehicle is located in the neighboring lane over a lane marking for partitioning the host vehicle travel lane and the neighboring lane.

9. The vehicle control device according to claim 2, wherein the driving controller is configured to start lateral movement of the host vehicle to the neighboring lane when the stopping conditions are not satisfied within the first predetermined time after the stopping conditions have been satisfied before the outside of the host vehicle has been notified of the lane change destination by the outside notifier or when the stopping conditions are not satisfied within the second predetermined time after the stopping conditions have been satisfied after the outside of the host vehicle has been notified of the lane change destination by the outside notifier.

10. A vehicle control method which is performed by an onboard computer, the vehicle control method comprising:
recognizing surrounding conditions of a host vehicle;
controlling one or both of speed and steering of the host vehicle on the basis of the recognized surrounding conditions;
causing an outside notifier to notify an outside of the host vehicle of a lane change destination of the host vehicle; and
changing a time or a distance until lane change from a host vehicle travel lane in which the host vehicle is traveling to a neighboring lane which is adjacent to the host vehicle travel lane is stopped depending on whether the outside of the host vehicle is notified of the lane change destination by the outside notifier when stopping conditions of the lane change are satisfied at the time of starting of the lane change.

11. A non-transitory computer-readable storage medium having a program stored therein, the program causing an onboard computer to perform:
recognizing surrounding conditions of a host vehicle;
controlling one or both of speed and steering of the host vehicle on the basis of the recognized surrounding conditions;
causing an outside notifier to notify an outside of the host vehicle of a lane change destination of the host vehicle; and
changing a time or a distance until lane change from a host vehicle travel lane in which the host vehicle is traveling to a neighboring lane which is adjacent to the host vehicle travel lane is stopped depending on whether the outside of the host vehicle is notified of the lane change destination by the outside notifier when stopping conditions of the lane change are satisfied at the time of starting of the lane change.
